(19) United States
(12) Patent Application Publication
(10) Pub. No.: US 2013/0251466 A1
(43) Pub. Date: Sep. 26, 2013

(54) INDEXABLE MILLING INSERT

(71) Applicants: K. Visweswara Rao, Bangalore (IN); Sharath Shankeregowda, Bangalore (IN); Shreelakshmi Krishnegowda, Bangalore (IN)

(72) Inventors: K. Visweswara Rao, Bangalore (IN); Sharath Shankeregowda, Bangalore (IN); Shreelakshmi Krishnegowda, Bangalore (IN)

(21) Appl. No.: 13/787,988

(22) Filed: Mar. 7, 2013

(30) Foreign Application Priority Data
Mar. 20, 2012 (IN) 1009/CHE/2012

(51) Int. Cl. B23C 5/20

(52) U.S. Cl. CPC B23C 5/207
USPC 407/113

(57) ABSTRACT

An indexable milling insert comprising a polygonal shaped body having an upper surface, a lower surface and side surfaces. The upper surface includes a peripheral land intersecting the side surfaces has a predetermined width (a) sloping downward at a predetermined angle (X). A support-face plateaux extending from an end of the peripheral land up to a chip shaping surface has a predetermined angle. The angle (X) of the peripheral land is more positive than the angle (Y) of the support face plateaux.

### FIELD OF THE INVENTION

The present disclosure relates to an indexable milling insert and more particularly relates to the land angle and topography of the milling insert, wherein the land angle has more positive angle than the topography angle.

### BACKGROUND OF THE INVENTION

Cutting inserts used in milling, drilling, turning etc need to have a proper topography or entry angle along with the right slope for the land with an exact land angle. Existing technology has land angle which is negative or less positive than the topography or entry angle. This kind of arrangement in the insert results in thicker chip formation and requires higher cutting forces which in turn creates more structural and thermal loading on the cutting edge of the insert. This causes the insert to heat up and reduces the tool life of the insert.

Existing inserts with the above said configuration leads to lesser shear plane angle in the primary shear deformation zone of the work material resulting in thicker chip formation of the work material during the cutting process. By increasing the shear plane angle, less force is required to cut the material. In the conventional negative or lesser positive sloped land is followed by a more positive sloped topography. Negative or less positive sloped land compared to high positive sloped topography has higher strength but leads to severe loading on the cutting edge both structurally and thermally and resulting in higher wear on the cutting edge thus reducing the life of the cutting edge.

Hence, there exists a need to develop topography to provide a land angle (X) which is more positive when compared to the support-face plateaux angle (Y). This configuration results in higher shear plane angle, thinner chip formation, lesser cutting forces and lesser heat generation.

### SUMMARY OF THE INVENTION

The shortcomings of the prior art are overcome and additional advantages are provided through the provision as claimed in the present disclosure. Additional features and advantages are realized through the techniques of the present disclosure. Other embodiments and aspects of the disclosure are described in detail herein and are considered a part of the claimed disclosure.

In an embodiment of the disclosure an indexable milling insert is disclosed wherein, a polygonal shaped body having an upper surface, a lower surface and side surfaces forming the insert body. The upper surface is characterized into a peripheral land which intersects the side surfaces having a predetermined width and a slope sloping downward at a predetermined angle. A support-face plateaux having a predetermined angle extends from the end of the peripheral land till the start of the elevated slope and the angle of the peripheral land is more positive compared to the angle of support-face plateaux.

In an embodiment of the disclosure an indexable milling insert is disclosed, wherein width of the peripheral land from the tip of the cutting edge to the start of the support-face plateaux ranges from about 0.001 to 0.5 mm.

In an embodiment of the disclosure an indexable milling insert is disclosed, wherein angle of the peripheral land results in higher shear plane angle in primary shear deformation zone of work material.

In an embodiment of the disclosure an indexable milling insert is disclosed, wherein lesser positive angle results in better distribution of structural, thermal loading and temperature gradients in the milling insert.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIGS. 1 and 2—illustrates cut sectional view of the insert showing land angle and topography or entry angle.

FIG. 3—illustrates top view, side view and top perspective view of the indexable milling insert.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE INVENTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Referring now to the drawings wherein the drawings are for the purpose of illustrating a exemplary embodiment of the disclosure only, and not for the purpose of limiting the same.

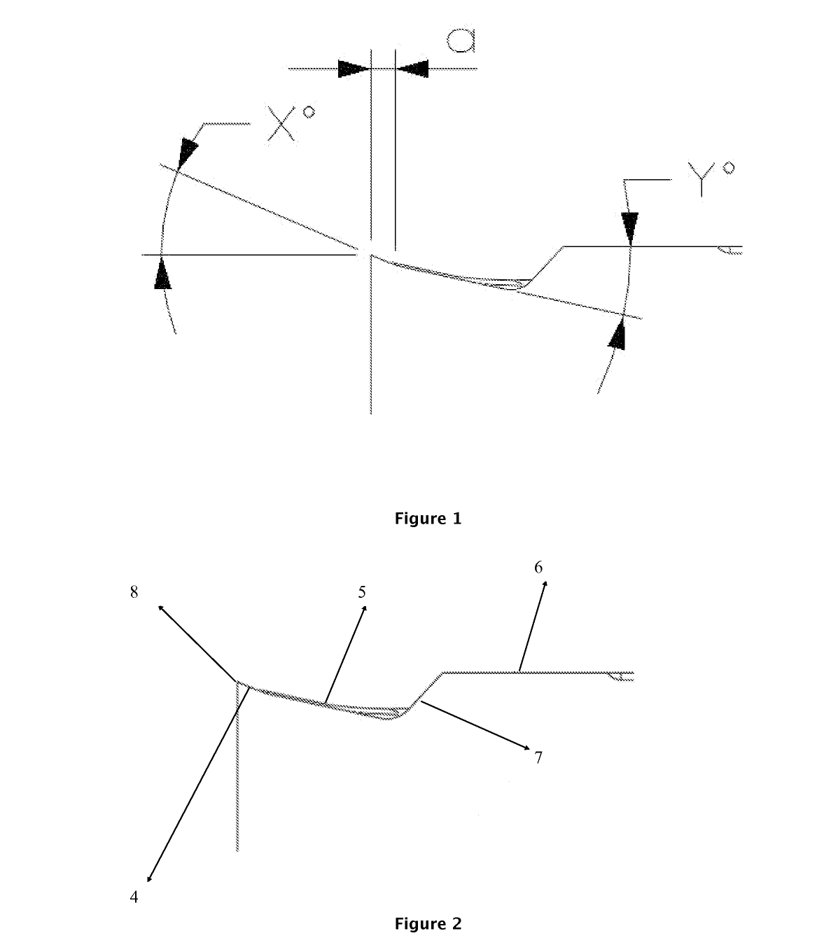

FIGS. 1 and 2 is an exemplary embodiment of the disclosure and illustrates cut sectional view of an polygonal shaped body indexable milling insert, the insert showing the parts of an insert, the insert has an upper surface (1), a lower surface (2) and side surfaces (3). The upper surface (1) of the indexable milling insert has a cutting edge tip (8) which cuts through the work piece in the form of metal chips. The tip of cutting edge (8) has a peripheral land (4) which is slopped downward from the tip of the cutting edge (8) to the start of the support-face plateaux (5). The slope of the peripheral land (4) is angled at a predefined angle and is called as the land angle (X). The land angle (X) is a more positive angle when compared to the support-face plateaux angle (Y) as against to the standard or conventional insert. The peripheral land (4) has a defined width (a) and ranges in millimetres from about 0.001 to 0.5 mm. The peripheral land angle (X) is the most crucial part of the insert and the peripheral land angle (X) ranges from about 0°1″ to 33°. The support-face plateaux (5) structurally and thermally help distribute the severe loading factors occurring on the tip of cutting edge (8). The severe loading on the tip of cutting edge (8) leads to decreased tool life of the insert. The elevated slope (7) starts from the end of the support-face plateaux (5) and slopes upward up to the tip of the chip-shaping element (6) present on the upper deck of the insert. The angle (Y) is less positive when compared to the peripheral land angle (X) and ranges from about 0° to 32°59″. The support-face plateaux (5) and its corresponding angle (Y) have lesser positive sloped topography helps in better distribution of structural and thermal loading leading to lesser stress and temperature gradients in the cutting insert. The topography design in the present disclosure has slope of the peripheral land (X) more positive when compared to the support-face plateaux angle (Y). Higher positive sloped land results in higher shear plane angle in the primary shear deformation zone of the work material. This higher shear plane angle leads to formation of thinner chips. The thinner chip leads to lesser cutting forces and lesser structural loading on the tip of cutting edge (8).

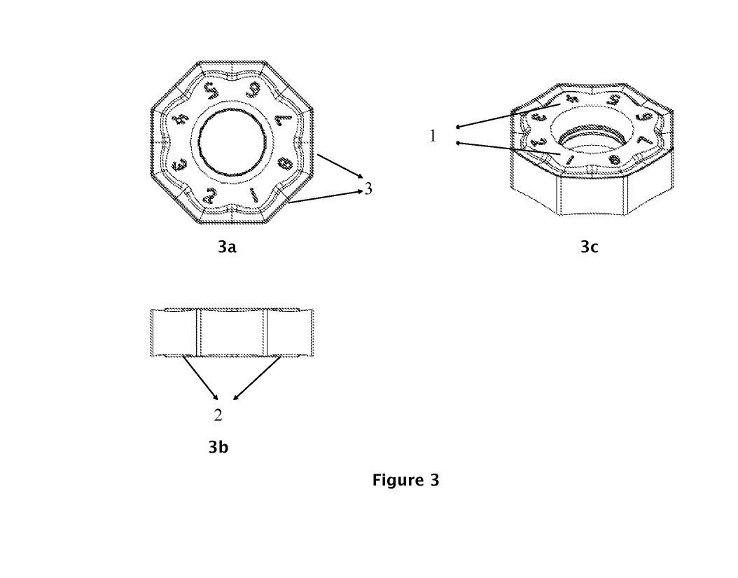

FIGS. 3a, 3b and 3c is an exemplary embodiment of the disclosure and illustrates the top view, side view and top perspective view of the milling insert. The top view shows the side surfaces (3) of the milling insert, the top perspective view shows the upper surface (1) of the indexable milling insert, which shapes the chips during machining process. FIG. 3c illustrates the upper surface (1) and lower surface of the indexable milling insert.

Advantages

The work required to shear the work material is less leading to lesser heat generation during cutting process. Higher shear plane angle leads to lesser tool/chip interface contact length, lesser sticking/sliding friction resulting in lesser interface temperature and thus lesser wear on the cutting edge. Interface contact length is greatly reduced and surface integrity of machined surface can be achieved due to this. Based on the machining conditions the width of the land (a) can be optimized, proper land width along with the combination of angles results in better chip control.

Reference Numerals

| X | Land Angle |
|---|---|
| Y | Support-face plateaux angle |
| a | Peripheral land width |
| 1 | Upper surface |
| 2 | Lower surface |
| 3 | Side surfaces |
| 4 | Peripheral land |
| 5 | Support-face plateaux |
| 6 | Chip shaping surface |
| 7 | Elevated slope |
| 8 | Tip of cutting edge |

Equivalents

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A indexable milling insert comprising:
polygonal shaped body having an upper surface, a lower surface and side surfaces;
wherein the upper surface (1) includes a peripheral land intersecting the side surfaces having a predetermined width (a) sloping downward at a predetermined angle (X), and a support-face plateaux extending from an end of the peripheral land up to an elevated slope, the support-face plateaux having a slope of a predetermined angle (Y); and
wherein the angle (X) of the peripheral land is more positive than the angle of the support-face plateaux.

2. The indexable milling insert as claimed in claim 1, wherein the width (a) of the peripheral land from the tip of cutting edge to the start of the support-face plateaux ranges from about 0.001 to 0.5 mm.

3. The indexable milling insert as claimed in claim 1, wherein the angle (X) of the peripheral land results in a higher shear plane angle in a primary shear deformation zone of a work material.

4. The indexable milling insert as claimed in claim 1, wherein the lesser positive angle (Y) compared to the higher positive angle (X) results in distribution of structural, thermal loading and temperature gradients in the milling insert.
